(19) United States
(12) Patent Application Publication
(10) Pub. No.: US 2011/0271805 A1
(43) Pub. Date: Nov. 10, 2011

(54) Hydraulic Saw System

(76) Inventors: Chad Abadie, Crowley, LA (US); Clint Musemeche, Youngsville, LA (US); Clayton Claxton, Lafayette, LA (US)

(21) Appl. No.: 13/100,809

(22) Filed: May 4, 2011

Related U.S. Application Data
(60) Provisional application No. 61/331,921, filed on May 6, 2010.

(51) Int. Cl. B26D 1/00; B26D 7/02

(52) U.S. Cl. 83/13; 83/452

(57) ABSTRACT

A saw apparatus having a saw body with a front portion and a rear portion and two motors position on the body. A circular saw blade is mounted on each of said motors. The saw blades are oriented such that (i) a circumferential perimeter of the saw blades are in substantially the same plane; and (ii) a center of a first saw blade is positioned closer to the front portion of the saw body than is the center of a second saw blade.

This application claims the benefit under 35 USC §119(e) of US provisional application serial no. 61/331,921 filed May 6, 2010, which is incorporated by reference herein in its entirety.

### FIELD OF INVENTION

The present invention pertains to methods and apparatuses for mechanically cutting and removing tubular members including, but not limited to, casing from oil and gas wells.

### BRIEF DESCRIPTION OF THE DRAWINGS

FIG. 1 is a perspective view of one embodiment of the present saw apparatus utilized in a hanging configuration.

FIG. 2 is a top view of the saw apparatus of FIG. 1 with the top body plates removed.

FIG. 3 illustrates the saw apparatus with saw blades removed to show saw motors.

FIG. 4 illustrates one embodiment of a gripping tool which, in certain embodiments, may be used in conjunction with the saw apparatus.

FIG. 5 is a side view of the saw apparatus of FIG. 1.

FIGS. 6A and 6B are hydraulic diagrams associated the illustrated embodiments of the saw apparatus and gripping tool.

FIG. 7 illustrates a saw apparatus mounted on a hydraulic jack basket.

### DETAIL DESCRIPTION OF SELECTED EMBODIMENTS

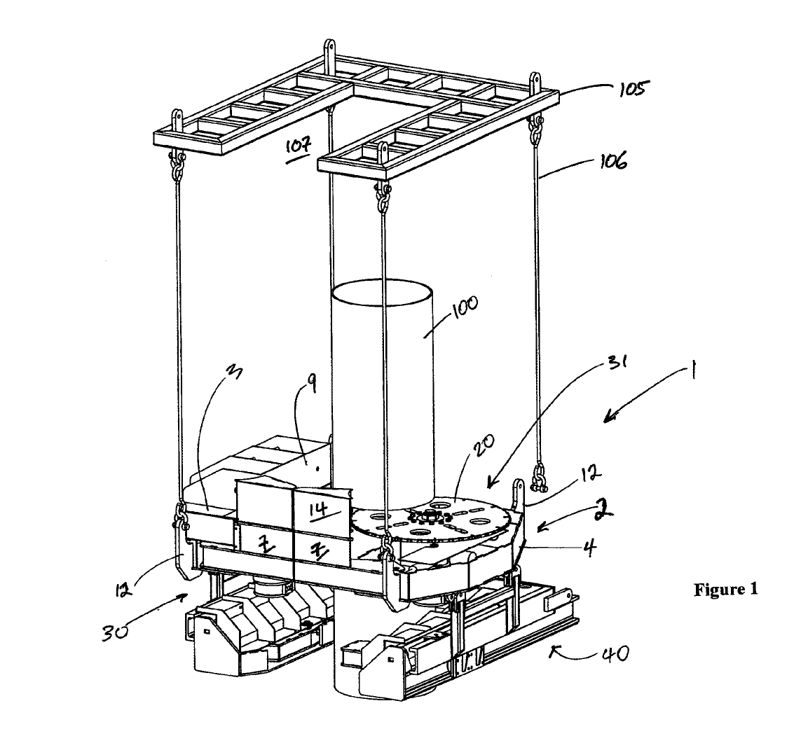

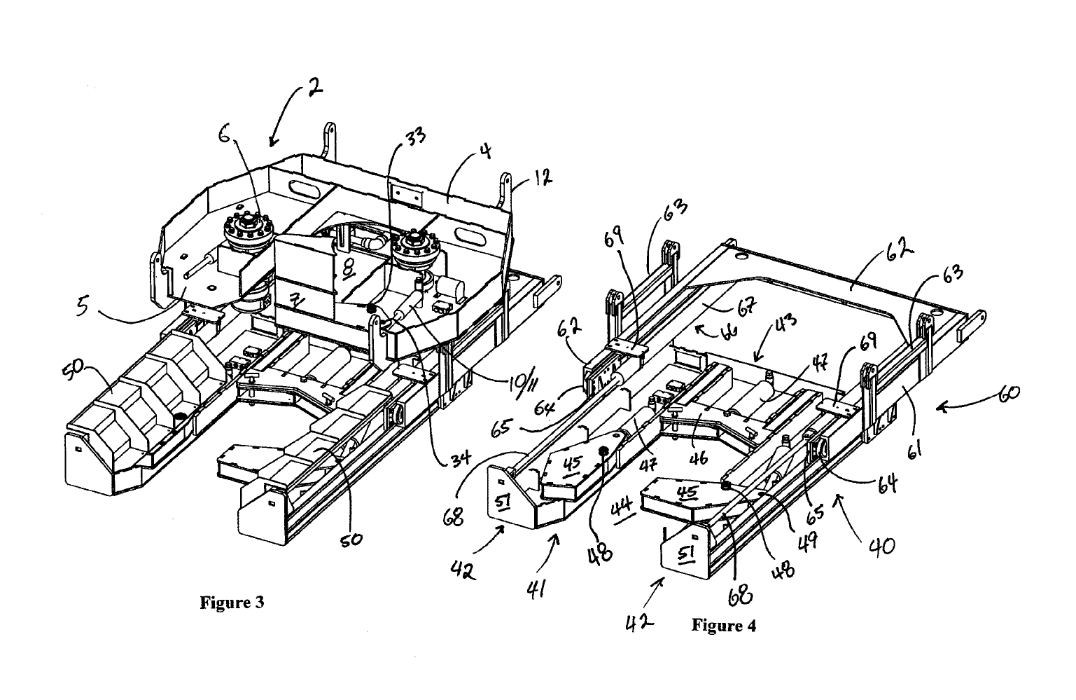

One embodiment of the saw apparatus of the current invention is illustrated in FIG. 1. This embodiment of saw apparatus 1 generally comprises a saw body 2 having a front portion 30 and a rear portion 31. Saw body 2 includes top plate 3 (shown partially removed in FIG. 1), side plates 4, and bottom plate 5 (shown exposed in FIG. 3). FIGS. 1 and 3 illustrate a pair of saw doors 7 which may open and shut to expose and close off the U-shaped throat 8 (FIG. 3). FIG. 1 also shows a section of saw shield wall 9 which is a raised wall generally following the perimeter of U-shaped throat 8. Similarly, raised door panels 14 are generally the same height as shield wall 9 and thus, when doors 7 are closed, the throat area where the saw blade 20 engage a tubular is enclosed on all sides to contain flying debris generated in the cutting process. FIG. 3 shows how doors 7 are attached to saw body 2 at pivot points 33 and doors 7 are further engaged by linear actuators 10 at rod connection points 34. In the embodiment of FIG. 3, the linear actuators are piston and cylinder assemblies 11. It can readily be understood how the extension and retraction of the rods of piston and cylinder assemblies 11 will cause doors 7 to pivot to the closed and open position, respectively. Naturally, alternative embodiments could be constructed without shield wall 9 or doors 7.

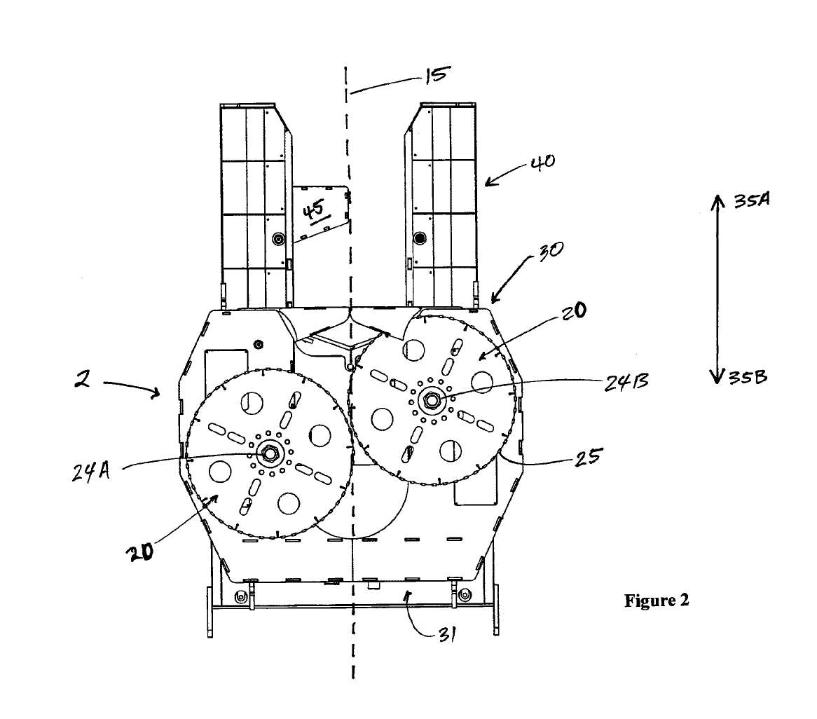

FIG. 2 is a top view of saw body 2 with all top plates 3 removed to more clearly show two circular saw blades 20 having center points 24. It can bee seen in this embodiment that the center point 24B of one saw blade 20 is closer to the saw front end 30 than the center point 24A. This offset positioning of saw blades 20 allows the circumferential perimeter of both saw blades to slightly overlap saw centerline 15. It will be understood that having both saw blades 20 overlap centerline 15 ensures that the entire cross-section of the tubular member will be completely severed. It can be seen that both saw blades 20 are in (or at least substantially in) the same plane, i.e., the flat surfaces of the two saw blades are parallel with their circumferential perimeter at the same height such that these perimeters would meet if the saw blades were not offset in the forward/rearward direction. However, it may be possible for alternative embodiments to not necessarily have blades overlapping the centerline, the blades offset, or the blades in the same plane.

In the illustrated embodiments, saw blades 20 are circular blades having a diameter of about 48 inches. However, other embodiments might have saw blades with diameters ranging from about 12 inches to about 72 inches, including any sub-range therebetween (or even outside this range in specialized embodiments, i.e., about 2 to 12 inches or about 72 to about 120 inches). Typically, the two saw blades on the saw body 2 will be the same diameter, but specialized embodiments could have two saw blades of differing diameters. Although the illustrated embodiments show two saw blades, alternate embodiments might employ a single saw blade or conceivably more than two saw blades. The saw blades 20 may be constructed of conventional ¾″ steel plate such as grades T-1 or H-90, but could be constructed of many different materials which are capable of withstanding the mechanical/heat stresses associated with the sawing process. In certain embodiments, the teeth of the saw may be formed of a carbide metal material such as tungsten carbide. In these embodiments, the perimeter of the steel plate does not have teeth cut into it, but teeth of tungsten carbide approximately ⅜″ long and ¾″ thick are attached to the steel plate perimeter by a conventional brazing process. In a preferred the embodiment, the teeth are formed of tungsten carbide chips about ¼″×⅜″ in size which have been brazed together, but the tungsten carbide chips could be smaller or larger. In alternative embodiments, the teeth may be cut directly into the steel plate or formed by any other conventional or future developed process. Likewise, teeth cut from the steel plate could be subject to temperature hardening treatments or could be covered with armor coating (e.g., a tungsten carbide power or granules brazed onto the teeth.

As suggested by FIG. 3, the illustrated embodiment of saw body 2 includes two motors 6, i.e., one motor 6 corresponding to each saw blade. In one embodiment, the motors 6 are hydraulic motors such as model no. 37 manufactured by Rineer Hydraulics, Inc. of San Antonio, Tex. However, motors 6 could be operated by other power sources such as pneumatic, electric, or internal combustion, although hydraulic or pneumatic are preferred in an oil/gas industry environment to minimize spark/explosion hazards. While the illustrated embodiments show a separate motor for each saw blade, other embodiments might employ fewer motors than saw blades or fewer saw blades than motors. For example, a single motor could drive two or more saw blades by employing an appropriate gearing system which distributes torque from the single motor to multiple power shafts on which the saw blades are mounted. In certain embodiments, motors 6 will rotate the saw blade in the range of about 50 rpm to about 100 rpm, but other rotation speeds may be used in other embodiments.

The illustrated embodiments of saw apparatus 1 are connected to a gripping tool 40. Gripping tool 40 could be any conventional or future developed device for gripping tubular members, including various conventional “backup power tongs” or “casing tongs.” In the embodiments shown in the figures (particularly FIGS. 3 and 4), gripping tool 40 generally comprises a tool body 41 which includes two forward arm sections 42 and a rear body section 43 which form a U-shape throat 44 generally corresponding to the previously described throat 8 on saw body 2. While FIG. 3 illustrates forward arm sections 42 with cover plates 50, FIG. 4 illustrates the cover plates 50 removed to show pivoting jaws 45 positioned within forward arm section 42 (with one jaw 45 in the open position and one jaw 45 in the closed position. Pivoting jaws 45 will be pivotally connected to forward arm sections 42 at jaw pivot points 48. The rod ends of linear actuators 47 will connect to pivoting jaws 45 at rod connection points 49. It can be seen from FIG. 4 how the extension and retraction of linear actuators 47 cause jaws 45 to pivot between the closed and open positions, respectively. A third jaw, axial jaw 46 is positioned in the rear body section 43 of gripping tool 40. Axial jaw 46 does not rotate, but rather moves in a straight or axial path into and out of the space of U-shaped throat 44 by its own linear actuator 47. In the illustrated embodiment, linear actuators 47 are double acting hydraulic piston and cylinder assemblies, but could be any suitable alternative linear actuator.

Although not explicitly shown, it will be understood that jaws 45 and 46 will include a gripping surface such as convention tong jaw die inserts. It will be apparent that with pivoting jaws 45 in an open position, gripping device 40 may engage a tubular such that the tubular is positioned within throat 44. Thereafter, the linear actuators 47 may be activated to cause all three jaws to close upon and securely hold the tubular.

The illustrated embodiments also include a positioning mechanism 60 which provides for relative forward and rearward movement between the saw body 2 and the gripping tool 40. Viewing FIGS. 3 and 4, this example of positioning mechanism 60 will include bearing channels 61 spaced apart by rear frame member 62. The bearing channels 61 will be engaged by rollers 64 which ride within bearing channels 61. Rollers 64 are mounted on roller brackets 65, which in turn are secured to the gripping tool body 41. Saw brackets 63 are welded to the outer surface of bearing channels 61 and connect to saw body 2 as suggested by FIG. 3.

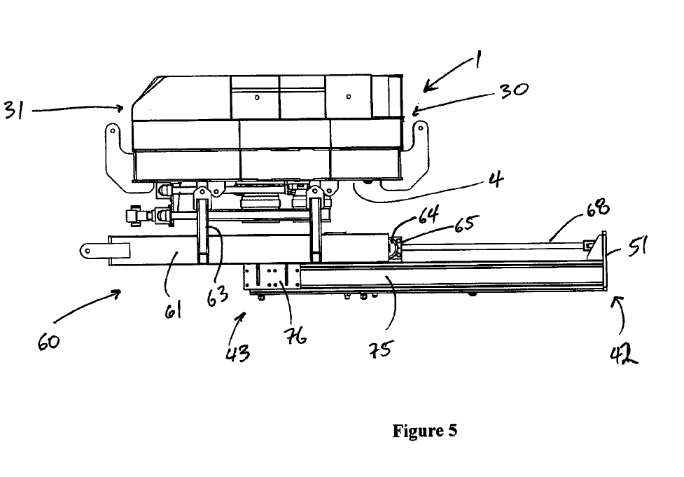

It is seen in FIG. 4 how linear actuators 66 (e.g., cylinder body 67 and piston arm 68) will operate to provide for relative movement between gripping tool 40 and saw body 2. The bearing channels 61 are rigidly connected to and move with cylinder body 67 via piston brackets 69. The ends of piston arms 68 connect to front plates 51 of front arm sections 42. It will be understood that retraction of piston arms 68 into cylinder bodies 67 will pull bearing channels 61 (and thus saw body 2 via saw brackets 63) toward the front of gripping tool 40. Likewise, extension of piston arms 68 will move saw body 2 toward the rear of gripping tool 40. The direction of movement is illustrated in FIG. 2 by forward directional arrow 35A and rearward directional arrow 35B. As more clearly seen in FIG. 5, the illustrated embodiment of positioning mechanism 60 further includes a lower set of bearing channels 75 engaged by rollers (the rollers are hidden from view in FIG. 5 with only the roller bracket 76 being visible). In this configuration, bearing channels 61 and rollers 64 are consider an “upper” set of bearing channels and rollers.

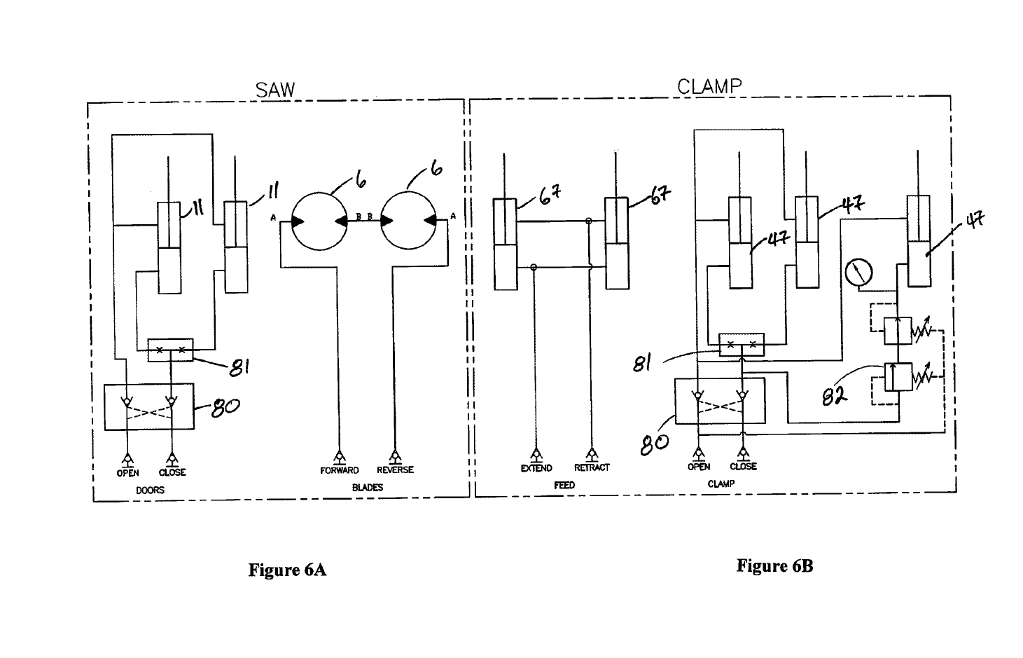

FIGS. 6A and 6B illustrate example hydraulic circuits which could be employed with the saw and gripping tool shown in the Figures. In FIG. 6A, the circuit for saw body 2 includes cross-port check valve 80 and dual-port value 81 which supply pressurized hydraulic fluid to double acting piston and cylinder assemblies 11 to open and close saw doors 7. Likewise, hydraulic motors 6 will be fed by two hydraulic lines allowing forward and reverse operation of the motors. In preferred embodiments, the saw blades will counter rotate during the cutting operation. For example, viewing FIG. 2, the left side saw blade 20 would rotate clockwise while the right side saw blade 20 would rotate counter-clockwise. This direction of counter rotation tends to draw the tubular into the blades and is advantageous when cutting larger diameter tubulars (e.g., 7″ to 30″ in diameter). However, the opposite direction of rotation (i.e, left side saw blade counter-clockwise and right side saw blade clockwise) tending to push the tubular away from the saw blades may be advantageous for smaller diameter tubulars (e.g., less than 7″).

FIG. 6B shows a similar circuit where double acting piston and cylinder assemblies 67 will be extended and retracted to change the relative position of saw body 2 to gripping tool 40. Gripping tool 40 includes cross-port check valve 80, dual-port value 81, and check valves 82 which supply pressurized hydraulic fluid to double acting piston and cylinder assemblies 47 to open and close jaw members 45 and 46.

Returning to FIG. 1, this embodiment of saw apparatus 1 illustrates its use in a hanging configuration. An hanging (or overhead) bridle assembly 105 which will use steel rods (or alternatively cables) 106 which are secured to hanger brackets 12. It can be seen how this embodiment of bridle assembly 105 is also generally U-shaped to accommodate a length of casing 100 which may extend above the height of bridle assembly 105. Bridle assembly 105 is in turn lifted by a crane or other lifting device being employed in the work area and saw apparatus 1 will be moved on and off tubulars in a manner which allows gripping tool 40 to grip and release the tubular. In one typical example of a sawing operation, the gripping tool 40 will be moved onto a tubular while the saw body 2 is in the rearward position. After the gripping tool has firmly grasped the tubular, the saw body (with blades rotating at an appropriate rpm) will move forward under the influence of positioning mechanism 60 and thereby cause the saw blades to engage and cut through the tubular as the saw body advances forward relative to gripping tool 40.

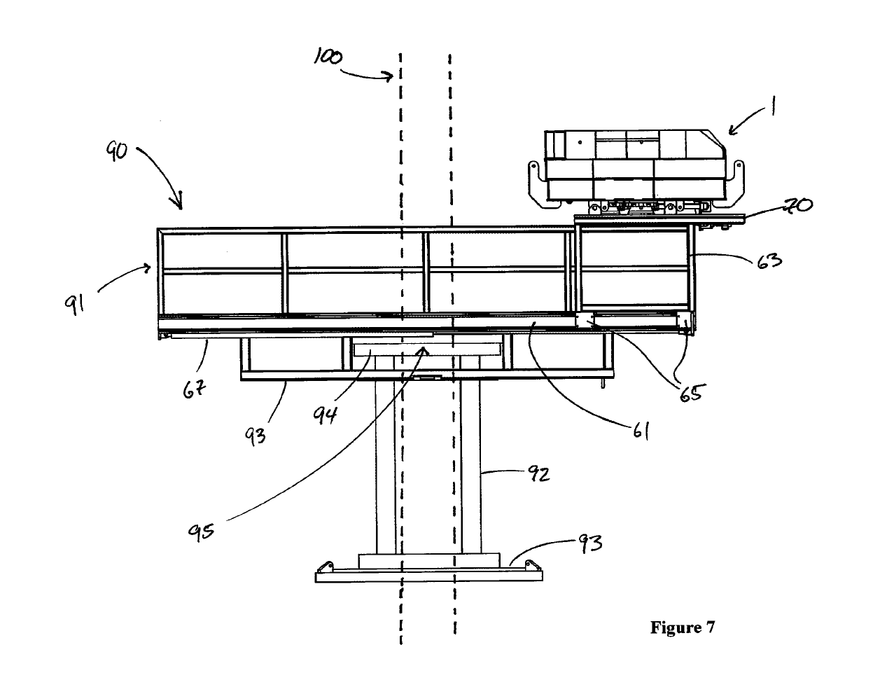

FIG. 7 illustrates an alterative technique employing saw apparatus 1 in the environment of a hydraulic jack basket 90. Hydraulic jack basket 90 includes a working basket section 91 which is supported on basket support 94. Basket support 94 is in turn supported hydraulic jacks 92 which can raise and lower working basket section 91 relative to the base plate 93 on which the hydraulic jacks 92 are positioned. Although not seen in the side view of FIG. 7, it will be understood that a center aperture 95 extends through base plate 93, basket support 94, and the floor of working basket section 91 such that casing or other tubulars 100 may extend therethrough. Base plate 93 may be positioned on any existing drilling platform or other structure through which the casing or other oilfield tubular extends.

FIG. 7 illustrates how saw apparatus 1 may be positioned on working basket section 91. Bearing channels 61 may be position along the base of working basket section 91 and be engaged by rollers on roller brackets 65. The frame support structure 63 will connect to roller brackets 65 and saw platform 70 to which saw apparatus 1 is connected. While largely hidden from view, a portion of cylinder bodies 67 can be seen connected between roller brackets 65 and the end of working basket section 91 distal from saw apparatus 1. It can be understood how the operation of cylinder bodies 67 will move saw apparatus 1 into and out of engagement with tubular 100 to effect cutting operations.

The current invention also includes the following Embodiments A to D. Embodiment A includes a saw apparatus comprising (a) a saw body having a front portion and a rear portion; (b) at a least two motors position on the body; and (c) a circular saw blade mounted on each of said motors, said saw blades oriented such that: (i) a circumferential perimeter of the saw blades are in substantially the same plane; and (ii) a center of a first saw blade is positioned closer to the front portion of the saw body than is the center of a second saw blade. Variations of Embodiment A include where motors are hydraulic motors and where the saw blades have diameters ranging between about 12 inches and about 72 inches.

Embodiment B includes a saw apparatus comprising (a) a saw body having a front portion and a rear portion; (b) at least one motor position on the body; (c) a circular saw blade mounted on the motor; and (d) a gripping tool including a positioning mechanism which provides relative forward and rearward movement between the between the saw body and the gripping tool. Variations on Embodiment B include (i) where the saw body comprises two motors with each motor having a saw blade positioned, thereon; (ii) where the saw blades are oriented such that a circumferential perimeter of the saw blades are in substantially the same plane; or (iii) where a center of a first saw blade is positioned closer to the front portion of the saw body than is the center of a second saw blade.

Embodiment C includes a saw apparatus comprising (a) a saw body having a front portion and a rear portion; (b) at a least two motors position on the body; and (c) a circular saw blade mounted on each of said motors, said saw blades oriented such that (i) a circumferential perimeter the saw blades are in substantially the same plane; and (ii) the circumferential perimeter of the saw blades both intersect a centerline of the saw body.

Variations on Embodiment C include (i) where a tubular gripping tool is connected to the saw body; (ii) where a center of a first saw blade is positioned closer to the front portion of the saw body than is the center of a second saw blade; (iii) where the saw blades have diameters ranging between about 12 inches and about 72 inches; (iv) where the saw blades are approximately the same diameter; or (v) where the saw blades have a metal body and hardened teeth.

Embodiment D includes 37 A saw apparatus comprising (a) a saw body having a front portion and a rear portion; (b) at least one motor position on the body; and (c) a circular saw blade mounted on the motor. Variations on embodiment D include (i) where a gripping tool including a positioning mechanism is connected to the saw body and provides relative forward and rearward movement between the between the saw body and the gripping tool; or (ii) where the saw body comprises two motors with each motor having a saw blade positioned thereon.

Although certain embodiments of the current invention have been described above, it will be understood that many variations of the illustrated embodiments are included within the scope of the current invention. For example, while the figures show a saw attached to a gripping tool, it will be understood that alternative embodiments of the saw could include a saw apparatus which is not used in conjunction with a gripping tool. Also, while the illustrated linear actuators (11, 47, 67) are double acting hydraulic piston and cylinder assemblies, such linear actuators would be pneumatic piston and cylinder assemblies, power screws, or any other conventional or future developed linear actuators. Furthermore, while the figures illustrate the saw apparatus operating in the horizontal position (e.g., the saw blades in a plane parallel to the ground surface), the saw apparatus could be rotated to saw at other orientations. Likewise, the saw could be employed both for surface and subsurface (i.e., sub-sea) operations. Although mainly described herein as cutting oilfield tubulars, the apparatus could be used to cut other items and could be scaled down to a size suitable for mounting on a push-cart or even for hand-held operations. All such variations are intended to fall within the scope of the following claims.

1. A saw apparatus comprising:
a. a saw body having a front portion and a rear portion;
b. at a least two hydraulic motors position on the body;
c. a circular saw blade mounted on each of said motors, said saw blades having diameters ranging between about 12 inches and about 72 inches and being oriented such that:
i. a circumferential perimeter of the saw blades are in substantially the same plane; and
ii. a center of a first saw blade is positioned closer to the front portion of the saw body than is the center of a second saw blade; and
d. a tubular gripping tool is connected to the saw body, wherein the connection between the saw body and the gripping tool includes a positioning mechanism which provides relative forward and rearward movement between the between the saw body and the gripping tool.

2. The saw apparatus of claim 1, wherein the saw blades are approximately the same diameter.

3. The saw apparatus of claim 1, wherein the saw blades have a metal body and hardened teeth.

4. The saw apparatus of claim 3, wherein the teeth include a carbide material formed thereon.

5. The saw apparatus of claim 1, wherein the circumferential perimeter of the saw blades both intersect a centerline of said saw body.

6. The saw apparatus of claim 1, wherein the saw body includes a U-shaped throat section.

7. The saw apparatus of claim 1, wherein a saw body shielding section extends above and below the saw blades.

8. The saw apparatus of claim 6, wherein at least one door closes across the throat section.

9. The saw apparatus of claim 8, wherein a pair of doors closes across the throat section.

10. The saw apparatus of claim 9, wherein a piston and cylinder assembly moves each of the doors sections between open and closed positions.

11. The saw apparatus of claim 1, wherein the positioning mechanism comprises at least two roller and bearing channel assemblies.

12. The saw apparatus of claim 1, wherein the positioning mechanism includes at least one linear actuator effecting relative movement between the gripping tool and the saw body.

13. The saw apparatus of claim 1, wherein the gripping tool includes a rear axially moving jaw assembly and at least one pivotally moving jaw assembly.

14. The saw apparatus of claim 13, wherein the gripping tool includes two pivotally moving jaw assemblies.

15. The saw apparatus of claim 14, wherein linear actuators moves the jaw assemblies between open and closed positions.

16. The saw apparatus of claim 1, wherein the saw body and tubular gripping tool are suspended from an overhead support assembly.

17. The saw apparatus of claim 16, wherein the overhead support assembly includes a U-shape generally conforming to a throat section in the saw body.

18. The saw apparatus of claim 1, wherein the saw body is positioned on a rig basket assembly and can move forward and rearward on the basket assembly.

19. The saw apparatus of claim 1, wherein the gripping tool is positioned beneath the saw body.

20. A method of cutting an oilfield tubular member comprising the steps of:
a. positioning a saw apparatus adjacent to a tubular member, the saw apparatus comprising:
i. a saw body having a front portion and a rear portion;
ii. at a least two motors position on the body;
iii. a circular saw blade mounted on each of said motors, said saw blades oriented such that: (1) a circumferential perimeter the saw blades are in substantially the same plane; and (2) a center of a first saw blade is positioned closer to the front portion of the saw body than is the center of a second saw blade;
iv. a gripping tool including a positioning mechanism which provides relative forward and rearward movement between the between the saw body and the gripping tool;
b. gripping the tubular member with the gripping tool while the saw body is in a rearward position;
c. operating the positioning mechanism such that the saw blades engage the tubular member.
